(19) United States
(12) Patent Application Publication
(10) Pub. No.: US 2007/0175765 A1
(43) Pub. Date: Aug. 2, 2007

(54) Method of fabricating monolayer abrasive tools

(76) Inventor: Kosta George, Southbridge, MA (US)

Correspondence Address: Kosta George, 22 Glen Ridge Road, Southbridge, MA, 01550, US

(21) Appl. No.: 11/344,496

(22) Filed: Feb. 1, 2006

(51) Int. Cl. C25D 5/54; B23F 21/03

(52) U.S. Cl. 205/158; 451/540

(57) ABSTRACT

A method for fabricating an abrasive tool. A tool substrate is provided. A surface of the substrate is coated with an electroplatable bonding agent which will chemically bond to the substrate. The electroplatable bonding material comprises a mixture of silver, leadless frit, terpineol, texinol, and copper salt. Abrasive particles are adhered to the bonding material. The abrasive particles are adhered so as to have a predetermined distribution over the coated surface of the substrate. After adhering abrasive particles, the bonding agent is dried and fired in a two step process. A metal layer is electroplated to the electroplatable bonding agent to further secure the abrasive particles to the substrate. Thus, in accordance with the present invention, the fabricated abrasive tool has abrasive particles having the predetermine distribution and fixed to the substrate by the bonding agent which is able to withstand high operating temperatures and the electroplated metal layer.

### BACKGROUND ART

The present invention pertains to a method of making a monolayer abrasive tool. More particularly, the present invention pertains to a method of making a monolayer abrasive tool having a predetermined spacing and concentration of abrasive particles.

The manufacturing of abrasive tools employing a monolayer of superabrasive particles is a relatively old art. The first monolayer tools date back to the turn of the century. Superabrasives are understood by those skilled in the art to mean synthetic or natural diamond, cubic boron nitride and any similar very hard abrasive materials.

Historically, the first monolayer abrasive tools were made by entrapping a mixture of diamond particles and beeswax. Placing that mixture in a thin chiseled angled slot allowing the upper thin steel lip to be rolled over the entrapped mixture in the steel substrate.

Traditional monolayer abrasive tools used in the market place were primarily of electroplate fabrication again utilizing mechanical entrapment of the abrasive particles (see FIG. 5). A shown, in accordance with the prior art abrasive particles 10 are secured the surface of a tool substrate 12 by a metal layer 14 electroplated to the tool substrate. In the late 1960's molecular (brazed) tools were successfully fabricated and introduced to the market place. The brazed process bonding diamond to a tool substrate using a hard, high strength. In the early 1970's, U.S. Pat No. 3,894,673 was issued.

Since then a lower temperature material with good strength was sought to reduce the premature fractures and structural break down of some particles caused by the high temperature and significant difference in coefficient of thermal expansion between the diamond and the which introduces certain stresses upon the diamond crystals. In the mid 90's U.S. Pat. No. 5,492,771 was issued. The patent teaches the use of a silver/copper brazed with titanium content for wetting to braze a monolayer of super abrasive particles including cubic boron nitride to avoid the fracturing and breakdown of the abrasive particles.

Conventional plated tools typically have a high concentration of abrasive particles resulting in high bearing (friction) pressure, poor chip and swarf evacuation and the tendency to run hot.

Abrasive tools formed by a brazing process, as shown in FIG. 6, have abrasive particles 10 adhered to the tool substrate 12 by a brazing material 16. These tools have the additional problem of splattered brazing material 18 adhering to the cutting surface of the abrasive particles. High temperature brazed products have better chip and swarf evacuation, but they also have particle fracture and physical diamond break down as well as other problems consistent with conventional plated tools, such as high bearing (friction) pressure. Low temperature brazed products have much of the same adverse effect as the high temperature brazed products with the exception of particle break down. This process has the added problem of metal smearing and particle pull out caused by hot running tools with the low temperature brazed metal.

A high temperature brazed abrasive tool is taught in U.S. Pat. No. 3,894,673. This patent teaches strategically spacing abrasive particles but includes the drawbacks of the high temperature used in brazing, premature fracturing and physical breakdown of some particles. As shown in FIG. 6, other problems with this tool include the braze material 18 being occasionally brazed on some particles and the metal side build up around all abrasive particles of up to 75-80% of the particle diameter.

A lower temperature brazing process is taught in U.S. Pat. No. 5,492,771 and the fracture and physical break down of some particles may be eliminated. However, the braze metal side build up is not. Also the lower temperature product has a lower strength of hardness and temperature resistance which causes abrasive particles to dislodge and/or the braze metal melt causing smearing over the abrasive particles.

Enomoto (Japanese publication 59-161267) teaches using a silver conductor with glue as a bonding agent to attach grinding particles to a steel substrate after curing at approximately 300 to 400 degrees Fahrenheit. Enomoto further teaches that the conductive surface is electroplated with nickel so that 60% or more of the particle diameter is covered with nickel. The drawback of this method is that the silver conductor with glue will disintegrate at approximately 300 degrees Fahrenheit. When this occurs, the nickel plating will flake and/or burn off, at which point the tool is no longer functional. Super abrasive tools grind at a much higher temperature as recognized in the art-when grinding plastics, let alone grinding glass, ceramics, iron, fiberglass, stainless steels and steel s, etc.

There have been prior attempts to improve upon existing technologies for monolayer abrasive tool fabrication. These attempts have failed to adequately provide a commercially satisfactory abrasive tool having a monolayer of superabrasive particles. Such a tool would be useful for a wide variety of abrasive applications that require cooler running tools for higher productivity and surface quality.

### SUMMARY OF THE INVENTION

It is an object of the present invention to overcome the drawbacks of the prior art. In accordance with the present invention, a monolayer of abrasive particles is bonded to a substrate for abrasive tool manufacturing using a process which provides for strategically placing diamonds-much like molecularly (brazed) products. A metal conductor consisting of silver, leadless frit, terpineol, texinol, and copper salt soluble is the preferred bonding agent. Such composite is available from Englehard under the trade name Silver Inks A6310XB and A6311XB. The material is then fired to a temperature of 1250° F. to 1300° F.

In accordance with the present invention, a monolayer abrasive tool is fabricated that will maintain structurally sound abrasive particles and allow chip and swarf clearance to increase productivity and quality. In accordance with the present invention, a conventional nickel plating process is utilized to form an abrasive tool having a control concentration of abrasive particles. The present invention reduces bearing pressure and overcomes the limitations of chip and swarf clearance, which conventionally resulted in hotter running tools that, for example, will melt plastic material. The present invention allows the abrasive tool to operate at temperatures higher than those manufactured under the prior art. It is anticipated that operating temperatures exceeding 1,000 degrees Fahrenheit will be achieved without conductor burn-off or flaking.

The resulting strategically plated tools have exhibited remarkable operating characteristics while controlling the particle concentration, tools made with the present invention allow tools to run at higher operating temperatures while maintaining structural integrity.

In accordance with the present invention, a method for fabricating an abrasive tool is provided. The steps of the inventive method include providing a tool substrate. Coating surface of the substrate with a conductive coating which will chemically bond to the substrate. The electroplatable conductive material comprises a mixture of silver, leadless frit, terpineol, texinol, and copper salt soluble. Abrasive particles are adhered to the bonding material. The abrasive particles are adhered so as to have a predetermined distribution over the coated surface of the substrate. The tool is then dried at a temperature of approximately 150 degrees centigrade. Subsequently, the tool is fired at a temperature of approximately 1250 to 1300 degrees Fahrenheit, which causes the bonding material to chemically bond to the substrate. Finally, a metal layer of nickel is electroplated to the bonding material to secure the abrasive particles to the substrate. Thus, in accordance with the present invention, the fabricated abrasive tool has abrasive particles having the predetermine distribution and fixed to the substrate by the chemically bonded material and the electroplated metal layer.

In accordance with a preferred embodiment of the present invention, the bonding agent comprises mixture of silver, leadless frit, terpineol, texinol, and copper salt soluble. The bonding agent is cured after adhering the abrasive particles to the bonding material. The curing of the electroplatable bonding agent comprises the steps of drying the bonding material at a temperature within a range of 100 through 150 degrees centigrade and then firing the dried bonding material at a temperature within a range of 1250 through 1300 degrees Fahrenheit. The electroplated metal layer may comprise of nickel.

Further, in accordance with the present invention an abrasive tool is provided. The inventive abrasive tool includes a substrate with an electroplatable agent applied to a surface of the substrate. The electroplatable bonding agent comprising a mixture of silver, leadless frit, terpineol, texinol, and copper salt soluble. Abrasive particles are adhered to the bonding material. The abrasive particles are adhered so as to have a predetermined distribution over the coated surface of the substrate. A nickel layer is electroplated to the electroplatable bonding agent to further secure the abrasive particles to the substrate. The inventive abrasive tool thus has abrasive particles having the predetermine distribution and fixed to the substrate by the adhesive material and the electroplated metal layer. Because of the nature of the fired bonding agent, the inventive tool has the ability to operate without breakdown at much higher temperatures, typical in the industry, than the prior art.

### BRIEF DESCRIPTION OF THE DRAWINGS

FIG. 1 is a cross section of an abrasive tool fabricated in accordance with the present invention;

FIG. 2 is a flowchart showing the steps of the inventive method for fabricating an abrasive tool;

FIG. 3 is a flowchart showing more detailed steps of the inventive method for fabricating an abrasive tool;

FIG. 4 is a depiction of the manufacturing steps of the inventive method for fabricating an abrasive tool;

FIG. 5 is a cross section of a prior art monolayer abrasive tool; and

FIG. 6 is a cross section of another prior art monolayer abrasive tool.

### DETAILED DESCRIPTION OF THE INVENTION

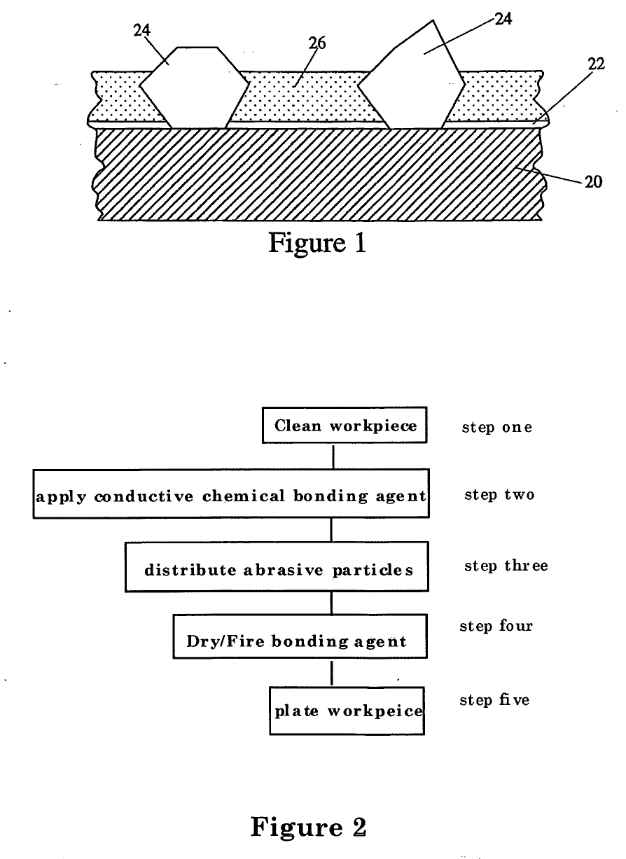

FIG. 1 is a cross section of an abrasive tool fabricated in accordance with the present invention. The inventive abrasive tool includes a substrate 20 with an electroplatable bonding agent 22 applied to a surface of the substrate. The electroplatable bonding agent 22 comprising a mixture of silver, leadless frit, terpineol, texinol, and copper salt soluble. Abrasive particles 24 are adhered to the bonding material. The abrasive particles 24 are adhered so as to have a predetermined distribution over the coated surface of the substrate. Following curing and firing, a nickel layer 26 is electroplated to the electroplatable bonding material 22 to further secure the abrasive particles 24 to the substrate 20. The inventive abrasive tool thus has abrasive particles 24 having the predetermined distribution and fixed to the substrate 20 by the adhesive material of the bonding layer 22 and the electroplated metal layer 26.

The inventive method for making an abrasive tool is effective for strategically controlling the concentration of abrasive particles to be entrapped by, for example, a nickel electroplated metal layer 26. The ability to control the spacing of the abrasive particles 24 include applying a bonding agent of silver, leadless frit, terpineol, texinol, and copper salt soluble to a steel substrate. Then a mono layer of superabrasive crystals of desired spacing is adhered to the bonding layer 22. The bonding layer 22 is allowed to stand for 5-10 minutes at ambient conditions following application. A two step drying/firing procedure is followed consisting of drying at a temperature within a range of 100 through 150 degrees centigrade and then firing the dried bonding material at a temperature within a range of 1250 through 1300 degrees Fahrenheit. This assembly is then conventionally nickel plated.

The present invention relates generally to methods of manufacturing monolayer superabrasive tools. Particularly to an improved method of adhering a monolayer of superabrasive particles to a variety of abrasive configurations when controlling the particle concentration and distribution with the discovery of a bonding agent, which will chemically adhere to the substrate and whose bond will survive the extreme temperatures typical to superabrasive grinding. The fired bonding agent, along with adhered superabrsasive particles is then ready for plating using conventional electrolytic nickel plating procedures.

As shown in FIG. 2, in accordance with the present-invention, a method for fabricating an abrasive tool is provided. The steps of the inventive method include providing a tool substrate (step 1). A surface of the substrate is coated with an electroplatable bonding agent which will chemically adhere to the substrate (step 2). The electroplatable bonding agent comprises a mixture of silver, leadless frit, terpineol, texinol, and copper salt soluble which will chemically adhere to the substrate. Abrasive particles are adhered to the bonding material. The abrasive particles are adhered so as to have a predetermined distribution over the coated surface of the substrate (step 3). The bonding layer is allowed to cure and fired (step 4). A metal layer is electroplated to the electroplatable bonding material to further secure the abrasive particles to the substrate (step 5). Thus, in accordance with the present invention, the fabricated abrasive tool has abrasive particles having the predetermine distribution and fixed to the substrate by the bonding agent and the electroplated metal layer, yet has the ability to withstanding higher temperatures than those found in prior art.

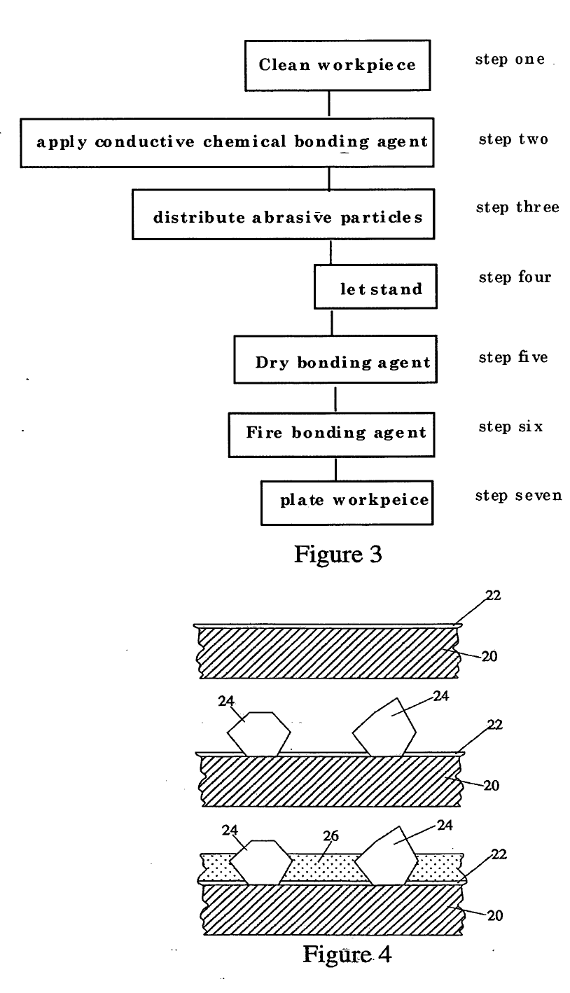

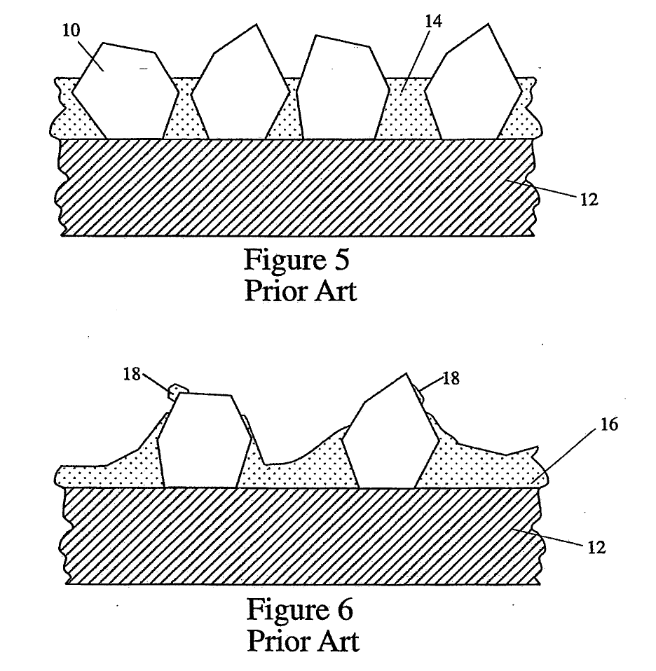

In prior art, conductive epoxy and/or glue has been used as a platform on which to hold superabrasive particles, which are primarily bonded to the substrate by a subsequent nickel plate. The conductive epoxy in prior art is susceptible to disintegrating, causing nickel to flake off at low operating temperatures. This conductive epoxy does not chemically bond to the substrate, and does not provide a high level of protection at normal to high operating temperatures. The present invention overcomes these drawbacks. As shown in FIG. 3, the inventive method for fabricating a monolayer of superabrasive particles for making an abrasive tool comprises the following steps: Degreasing/cleaning of the tool substrate or blanks (step 1). Applying a chemically bonding agent on the substrate, the bonding agent including, for example, a mixture of silver, leadless frit, terpineol, texinol, and copper salt soluble which can be purchased from Englehard under the trade name Silver Inks A6310XB and A6311XB (step 2). Placing a distribution of superabrasive particles having a desired spacing and concentration (step 3). Allowing to stand for 5-10 minutes at ambient condition following application (step 4). A two step drying procedure includes drying the part to remove solvent at 100-150° C. for approximately 5-10 minutes (step 5), and then firing at 1250-1300° F. for 5 minutes at temperature or more (step 6). A conventional electrolytic nickel plating procedure is performed for plating a nickel bond thickness until between 60 and 70% of the average diameter of the superabrasive crystal (step 7).

FIG. 4 shows the manufacturing steps of the inventive method for fabricating an abrasive tool. As shown in the first drawing image, a tool substrate 20 is provided and coated with a electroplatable bonding agent which will chemically adhere to the substrate 22. Next, as shown in the second drawing image, abrasive particles 24 are adhered to the bonding material 22 having a predetermined distribution. As shown in the third drawing image, a metal layer 26 is electroplated to the electroplatable bonding material 22 to further fix the abrasive particles 24 to the substrate 20.

The step of providing a substrate may include providing a metal substrate having a shape suitable for use as an abrasive tool, such as in the shape of a wheel or any suitable abrasive tool shape. The electroplatable bonding agent 22 must comprise a mixture, such as silver, leadless frit, terpineol, texinol, and copper salt, which will chemically bond to the substrate. The electroplatable bonding agent 22 is dried and then fired after adhering the abrasive particles 24 to the bonding material 22. The electroplated metal layer may comprise a nickel. Thus, in accordance with the present invention the distribution of abrasive particles may be accurately controlled to form an abrasive cutting tool having superior cutting and wear characteristics, yet will be able to withstand higher operating temperatures, as compared with the conventional art.

1) A method for fabricating an abrasive tool, comprising the steps of: providing a substrate; coating a surface of the substrate with an electroplatable bonding agent which will chemically bond to the substrate; adhering abrasive particles to the bonding material having a predetermined distribution; and electroplating a metal layer to the electroplatable bonding material to further fix the abrasive particles to the substrate.

2) A method for fabricating an abrasive tool according to claim 1; wherein the step of providing a substrate comprises providing an metal substrate having a shape suitable for use as an abrasive tool.

3) A method for fabricating an abrasive tool according to claim 2; wherein the shape of the metal substrate is a wheel.

4) A method for fabricating an abrasive tool according to claim 1; wherein the electroplatable bonding agent comprises a mixture which will chemically bond to the substrate, such as silver, leadless frit, terpineol, texinol, and copper salt.

5) A method for fabricating an abrasive tool according to claim 4; wherein the conductive material includes silver.

6) A method for fabricating an abrasive tool according to claim 4; wherein the bonding agent comprises a mixture of silver, leadless frit, terpineol, texinol, and copper salt.

7) A method for fabricating an abrasive tool according to claim 1; further comprising the step of drying and firing the electroplatable bonding agent after adhering the abrasive particles to the bonding material.

8) A method for fabricating an abrasive tool according to claim 7; wherein the electroplatable bonding agent comprises a conductive material which will chemically adhere to the substrate; and wherein step of treating the electroplatable bonding agent comprises the steps of drying the bonding material at a temperature within a range of 100 through 150 degrees centigrade and then firing the dried bonding material at a temperature within a range of 1250 through 1300 degrees Fahrenheit.

9) A method for fabricating an abrasive tool according to claim 1; wherein the step of adhering abrasive particles comprises adhering abrasive particles have a predetermined distribution over the coated surface of the substrate so that the fabricated abrasive tool has abrasive particles having the predetermine distribution and fixed to the substrate by the coated bonding material and the electroplated metal layer.

10) A method of fabricating an abrasive tool according to claim 1; where the electroplated metal layer comprises a nickel.

11) A method for fabricating an abrasive tool, comprising the steps of: providing a substrate; coating a surface of the substrate with an electroplatable bonding agent, the electroplatable bonding agent comprising a mixture of a conductive material which will chemically bond to the substrate; adhering abrasive particles to the bonding material, the abrasive particles being adhered so as to have a predetermined distribution over the coated surface of the substrate; and electroplating a metal layer to the electroplatable bonding material to secure the abrasive particles to the substrate so that the fabricated abrasive tool has abrasive particles having the predetermine distribution and fixed to the substrate by the adhesive material and the electroplated metal layer.

12) A method for fabricating an abrasive tool according to claim 11; wherein the adhesive agent comprises a mixture of silver, leadless frit, terpineol, texinol, and copper salt.

13) A method for fabricating an abrasive tool according to claim 11; further comprising the step of drying and firing the electroplatable bonding material after adhering the abrasive particles to the bonding agent.

14) A method for fabricating an abrasive tool according to claim 13; wherein the electroplatable bonding material comprises a conductive material which will chemically bond the substrate; and wherein step of treating the electroplatable bonding material comprises the steps of drying the bonding material at a temperature within a range of 100 through 150 degrees centigrade and then firing the dried bonding material at a temperature within a range of 1250 through 1300 degrees centigrade.

15) A method of fabricating an abrasive tool according to claim 11; where the electroplated metal layer comprises a nickel.

16) An abrasive tool, comprising; a substrate; an electroplatable bonding agent applied to a surface of the substrate, the electroplatable bonding agent comprising a mixture of a conductive material which will chemically bond to the substrate; abrasive particles adhered to the boding agent, the abrasive particles being adhered so as to have a predetermined distribution over the coated surface of the substrate; and a metal layer electroplated to the electroplatable bonding agent to further secure the abrasive particles to the substrate so that the abrasive tool has abrasive particles having the predetermine distribution and fixed to the substrate by the adhesive material and the electroplated metal layer.

17) An abrasive tool according to claim 16; wherein the adhesive agent comprises a mixture of silver, leadless frit, terpineol, texinol, and copper salt.

18) An abrasive tool according to claim 16; wherein the electroplated metal layer comprises a nickel.

19) An abrasive tool according to claim 16; wherein the conductive material includes silver.
